(19) United States
(12) Patent Application Publication
(10) Pub. No.: US 2024/0396763 A1
(43) Pub. Date: Nov. 28, 2024

(54) DEVICE AND MOBILE RADIO NETWORK-ASSISTED AUTOMATION SYSTEM

(71) Applicant: Phoenix Contact GmbH & Co. KG, Blomberg (DE)

(72) Inventor: Frank HAKEMEYER, Horn-Bad Meinberg (DE)

(21) Appl. No.: 18/682,014

(22) PCT Filed: Aug. 4, 2022
(86) PCT No.: PCT/EP2022/071962

§ 371 Date: Feb. 7, 2024

(30) Foreign Application Priority Data
Aug. 10, 2021 (DE) 20 2021 104 270.2

(51) Int. Cl. H04L 12/46; H04W 8/18

(52) U.S. Cl. CPC H04L 12/4633; H04W 8/183

(57) ABSTRACT

A device for use in a mobile radio network-based automation system, includes: a mobile radio communication interface, a memory device in which a program is stored which implements an IP-based tunnel protocol, a subscriber identity module in which configuration data is stored, the configuration data containing at least one parameter name and a parameter value which is assigned to the at least one parameter name and represents the IP address of at least one remote station, and a control unit which is designed to retrieve the configuration data, to execute the stored program as a function of the configuration data and, while executing the stored program, to cause the device to encapsulate at least one layer 2 protocol data frame which is ready for transmission in an IP packet and to transfer the IP packet to the mobile radio communication interface for transmission to the at least one remote station.

### FIELD

The invention relates to a device for use in a mobile radio network-based automation system and to such a mobile radio network-based automation system, which is preferably installed on a company site.

### BACKGROUND

In automation technology, especially in industrial automation technology, a variety of communication technologies are used today that enable communication according to the ISO/OSI reference model on the basis of a layer 2 communication protocol. A layer 2 communication is characterized, among other things, by the fact that the devices involved in a communication are addressed via their unique Media Access Control (MAC) addresses.

In contrast, packet-based data communication via mobile networks is usually realized using a layer 3 communication protocol, preferably the Internet Protocol, so that data packets can be routed across different networks.

Particularly since the introduction of the fourth generation mobile communications standard (also known as LTE-Advanced (Long-Term-Evolution-Advanced)) and at the latest since the discussions about the emerging fifth generation of mobile communications (5G), interest in using mobile communications technology in industrial applications, such as factory networks, process plants and the like, has risen sharply. A key aspect here is the use of non-public, i.e. private, mobile networks that are limited to a factory site. One approach currently under discussion is 5G campus networks, which are intended to provide companies with private mobile communications coverage directly on their premises. Information on 5G campus networks can be found at the Internet address “www.telekom.com/de/konzern/details/5g-Technologie-in-Campus-Netzen-556609”, for example.

One difficulty in integrating mobile phone technology into private factory networks and/or process plants is that data that is transmitted in a factory network or a process plant using a layer 2 protocol, such as an industrial Ethernet protocol, is to be transmitted at least in sections via a mobile phone network. So-called tunneling techniques are a common way of doing this. Examples of this are SSH tunneling technology, VPN tunneling technology or HTTP tunneling technology.

Devices that are to be used in a mobile network-based automation system must therefore be able to support both a layer 2 protocol and an IP-based tunneling protocol in order to be able to send and receive layer 2 data frames in IP-based data packets via a mobile network.

### SUMMARY

It is an object of the present invention to create a device which can be configured in a cost-effective and efficient manner for use in a mobile phone network-based automation system.

A core aspect of the invention can be seen in equipping a device, which is intended for use in a mobile radio network-based automation system, in particular with a mobile radio communication interface and a subscriber identity module, which can preferably be a conventional SIM card or a conventional e-SIM module. Configuration data, in particular information on the configuration of a tunnel, can be stored in the subscriber identity module, which contains at least one parameter value that can be interpreted by a control unit of the device as the IP address of a remote station. This enables the device to transmit IP packets to a remote station via a tunnel by encapsulating a layer 2 protocol data frame in an IP-based data packet and transferring the IP-based data packet, which may contain the parameter value in the form of an IP address of the remote station, to the mobile radio communication interface for transmission to the remote station.

Layer 2 data frames are formed according to the ISO/OSI reference model on the basis of a layer 2 communication protocol. In the ISO/OSI reference model, layer 2 is also referred to as the data link layer. Well-known layer 2 communication protocols are Ethernet-based communication protocols, such as industrial Ethernet protocols (also known as Industrial Ethernet). A well-known Industrial Ethernet protocol is Profinet. The ISO/OSI reference model is described, for example, in the textbook “Computer Networks, 4th, revised edition, by Tanenbaum, Andrew, S., Prentice Hall, 2003 by Pearson Studium”.

In this way, data communication in an automation system, which usually supports data communication according to a layer 2 communication protocol, can also take place at least in sections via a mobile radio network.

The above-mentioned technical problem is solved both by the features of claim 1 and by the features of claim 10. Advantageous embodiments are the subject of the dependent claims.

### BRIEF DESCRIPTION OF THE DRAWINGS

The invention is explained in more detail below by means of an exemplary embodiment in conjunction with the accompanying drawings. It shows:

FIG. 1 an exemplary device which is designed for use in a mobile radio network-based automation system, and

FIG. 2 an exemplary mobile radio network-based automation system on a factory site, which has the device shown in FIG. 1.

### DETAILED DESCRIPTION

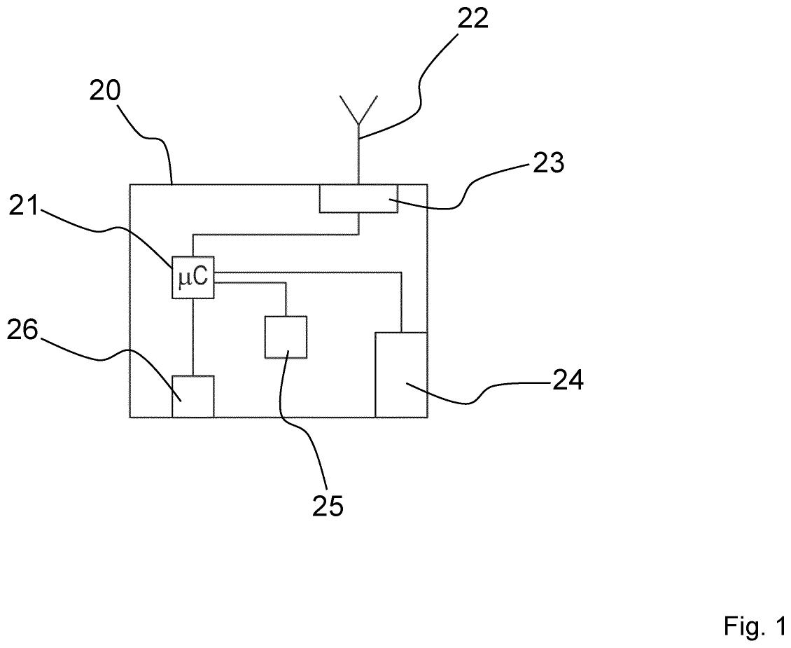

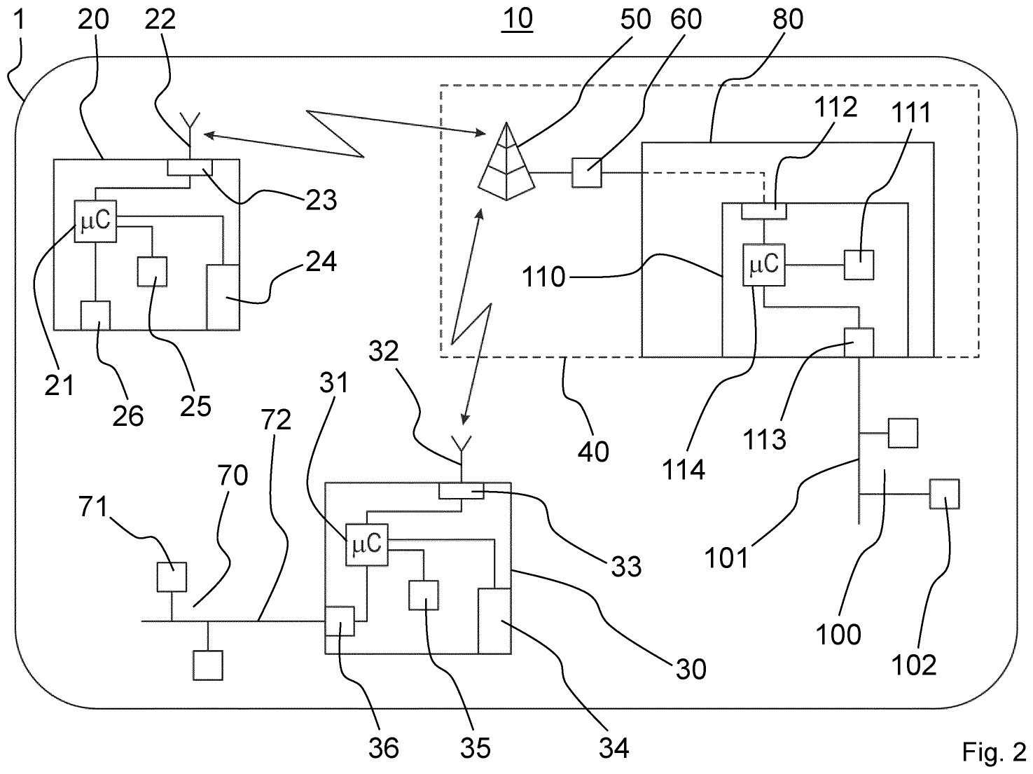

FIG. 1 shows an example of a device 20, in particular an electronic device, which can be used in a mobile radio network-based automation system 10, an example of which is shown in FIG. 2. The automation system 10 shown as an example in FIG. 2 can in particular be designed to control, regulate and/or monitor an industrial process, for example a chemical engineering process, a manufacturing process, a continuous or discontinuous process. Accordingly, the device 20 can preferably be a router, a field device, for example a sensor or actuator, a control device, for example a programmable logic controller, or an input/output module, also known as an I/O module.

For example, in order to be able to transmit process data wirelessly, at least in sections, the device 20 has a mobile radio communication interface 23, which is implemented for wireless data transmission in accordance with a mobile radio standard. The mobile radio standard can be, for example, the 3G mobile radio standard, the 4G mobile radio standard or the 5G mobile radio standard. The 3G mobile radio standard is also known as the Universal Mobile Telecommunications System (UMTS), while the 4G mobile radio standard is also known as the LTE or LTE-Advanced standard.

The mobile radio communication interface 23 preferably has a known mobile radio data card for data transmission, whereby the mobile radio data card is designed in accordance with a mobile radio standard. The mobile radio data card is also known as a radio modem. The mobile radio data card is generally connected to a transmit/receive antenna 22.

Furthermore, the device 20 has a memory device 25 in which a program that implements an IP-based tunnel protocol can be stored. The IP-based tunnel protocol can be, for example, known tunnel protocols such as the Generic Routing Encapsulation (GRE) network protocol, a virtual private network (VPN) protocol, an IPsec protocol or a Layer 2 Tunneling Protocol (L2TP). The program stored in the memory device 25 is used in particular to transmit layer 2 protocol data frames using the IP protocol.

Depending on the IP-based tunneling protocol implemented, process data that is packed into layer 2 protocol data frames can be transmitted in tunnels using a tunneling technique either via a tunnel connection previously established to a predetermined remote station or in accordance with datagram operation in individual IP packets, each of which contains the IP address of the predetermined remote station.

Furthermore, an Ethernet-based communication protocol, for example the Profinet protocol, can be implemented in the device 20 as a layer 2 protocol. It should be mentioned that, in a conventional manner, a layer 2 protocol data frame to be transmitted can preferably also contain the Medium Access Control (MAC) address of the device 20 as the source address and the MAC address of a destination device, which does not necessarily have to be the predetermined remote station, in addition to the user data.

So that the device 20 can receive and/or transmit layer 2 protocol data frames via a mobile radio network, a subscriber identity module 24 is implemented in the device 20, which can preferably be a conventional SIM card or a conventional e-SIM module. In the case of the device 20 explained by way of example below, it is assumed that a SIM card has been implemented as subscriber identity module 24.

In order to be able to transmit layer 2 protocol data frames to a predetermined remote station via a mobile radio network, the device 20 must be configured for mobile radio communication and for tunnel-based communication. In order to enable IP-based tunnel communication, information, also referred to as configuration data or tunnel configuration data, is stored in the subscriber identity module 24, wherein the configuration data includes, for example, at least one parameter value representing the IP address of at least one remote station. The configuration data may contain information about the stored program, for example the name of the implemented tunnel protocol, for example the name “GRE-Tunnel KONFIG” for the Generic Routing Encapsulation (GRE) network protocol. The configuration data can also contain, for example, the packet length of the IP packets as a further parameter value. Furthermore, the configuration data can contain at least one parameter name that refers to or names the respective parameter value.

It should already be mentioned at this point that the configuration data can have a predetermined data structure in order to be preferably stored in a SIM card or an e-SIM module. In particular, the configuration data can contain at least one parameter name and an associated parameter value. In a manner known per se, a SIM card or an e-SIM module contains a telephone book with name and call number fields in which a call partner and their call number can normally be entered. Preferably, the configuration data is now entered in the telephone book of the SIM card 24, whereby the name of a parameter is preferably entered in a name field and a parameter value is preferably entered in a call number field of the telephone book. It should also be mentioned that the name of a parameter can be, for example, “destination IP address” or “packet length” and the parameter value associated with the respective parameter name can be represented by a sequence of digits. Preferably, several different parameter names and associated parameter values for configuring a tunnel are each entered in a name field or a call number field.

The exemplary device 20 also has a control unit 21, which can be designed as a microcontroller. The control unit 21 is designed in particular to monitor and control the operation of the device 20. In addition, the control unit 21 can be designed to retrieve the configuration data stored in the subscriber identity module 24 and, depending on the configuration data read out, to execute the program stored in the memory device 25, whereby the control unit 21 causes the device 20 to encapsulate at least one layer 2 protocol data frame ready for transmission in an IP packet and to deliver the IP packet to the mobile radio communication interface 23 for transmission to at least one predetermined remote station. For this purpose, the control unit 21 can advantageously be designed to interpret the parameter value read out in dependence of the correspondingly assigned parameter name, for example as the destination IP address or as the packet length. For example, the sequence of digits “127255255001”, which is assigned to the parameter name “destination IP address”, can be interpreted by the control unit 21 as the destination IP address 127.255.255.001 and converted into the correct IP address 127.255.255.001, for example in order to establish a tunnel to a remote station with this IP address. Depending on the implementation, the control unit 21 may also be configured to insert the interpreted parameter in the header of each IP packet to be transmitted in the correct form of an IP address, namely the destination IP address 127.255.255.001, if no tunnel connection is to be established.

It should be noted that, depending on the implemented IP-based tunneling protocol, the control unit 21 causes the device 20 either
(1) before the actual data transmission, to establish a tunnel connection using the IP address, which is stored as a parameter value in the subscriber identity module 24, to the associated remote station and then to transmit the layer 2 protocol data frames to be transmitted in each case in an IP packet via the established tunnel connection to the remote station, or in accordance with a datagram operation
(2) to encapsulate each layer 2 protocol data frame to be transmitted in a separate IP packet, whereby the IP address of the remote station is added to each IP packet, which is preferably stored as a parameter value in a call number field of the telephone directory implemented in the subscriber identity module 24.

It should be noted at this point that the device 20 can be configured to generate process data itself and insert it into at least one layer 2 protocol data frame, which is then to be transmitted to the predetermined remote station in an IP packet via the mobile radio communication interface 23. In this case, the device 20 can be a field device, for example, which can be configured as a sensor, such as a temperature sensor. It is also conceivable that the device 20 can have a communication interface 26, which is configured to send and receive layer 2 protocol data frames. Preferably, a wired communication system that supports communication according to a layer 2 protocol can be connected to the optional communication interface 26. As already mentioned, the device 20 is implemented according to the Profinet protocol, for example. Via the communication interface 26, the device 20 could receive layer 2 protocol data frames from other devices of the automation system 10 and transmit layer 2 protocol data frames to other devices of the automation system.

FIG. 2 shows the aforementioned exemplary mobile radio network-based automation system 10. The exemplary mobile radio network-based automation system 10 can preferably be installed on a company site 1 which, for example, surrounds several buildings. The exemplary mobile radio network-based automation system 10 can, for example, have the device 20 shown in FIG. 1 and at least one other device, in this case a device 30. In the exemplary automation system 10, the device 20 is designed, for example, as a field device, in particular as a temperature sensor. In this case, the communication interface 26 implemented in accordance with a layer 2 protocol is not necessarily required for operation. However, it is conceivable that an external temperature measuring device transmits measured temperature values in layer 2 protocol data frames to the device 20 via the communication interface 26.

However, it is assumed that the device 20 itself can measure the temperature, for example the ambient temperature or the temperature of a monitored machine, and insert the corresponding temperature measurement data into at least one layer 2 protocol data frame. It should be noted that the device 20 can also be assigned an IP address in addition to a MAC address, which uniquely identifies the device. The MAC address is preferably inserted as the source address in the layer 2 protocol data frames to be transmitted. It is also assumed that a parameter value, which represents the IP address of the device 30 as the destination address of a remote station, is entered in the call number field of the telephone book as configuration data in the SIM card 24 of the device 20. This parameter value is assigned, for example, the parameter name “destination IP address”, which is stored in a name field of the telephone book. These entries specify that process data that is inserted into at least one layer 2 protocol data frame is to be transmitted, i.e. tunneled, from the device 20 to the device 30 in at least one IP packet.

Furthermore, it is assumed that an IP-based tunneling protocol is implemented in the device 20, which supports datagram operation, according to which process data to be transmitted is not transmitted to the device 30 via a previously established tunnel connection, but in the form of individual IP packets, each of which contains the IP address of the device 30 in addition to a layer 2 protocol data frame.

The device 30 can preferably be a higher-level control device, for example a programmable logic controller. The device 30 can be implemented substantially identical to the device 20. In particular, the device 30 can have a mobile radio communication interface 33, which is designed to transmit data in accordance with a mobile radio standard. It should be noted that the mobile radio communication interface 23 and the mobile radio communication interface 33 are designed in accordance with the same mobile radio standard. The mobile radio communication interface 33 preferably has a radio modem and a transmitting/receiving antenna 32 connected thereto. Furthermore, the device 30 has a memory device 35 in which a program is stored which implements an IP-based tunnel protocol. It should be noted that the program stored in the memory device 25 and the program stored in the memory device 35 implement the same IP-based tunnel protocol.

So that the device 30 can receive and/or transmit layer 2 protocol data frames via a mobile radio network, a subscriber identity module 34 is implemented in the device 30, which can preferably be a conventional SIM card or a conventional e-SIM module. In the device 30 explained below by way of example, it is assumed that a SIM card has been implemented as subscriber identity module 34.

In order to be able to transmit layer 2 protocol data frames via a mobile radio network to a predetermined remote station or to receive them from a remote station, the device 30 must be configured for mobile radio communication and for tunnel-based communication. In order to enable IP-based tunnel communication, configuration data, also referred to as tunnel configuration data, is stored in the subscriber identity module 34, the configuration data preferably containing the parameter name “destination IP address and a parameter value assigned to the parameter name, which represents the IP address of a remote station. The remote station may, for example, be the device 20, so that a sequence of digits representing the IP address of the device 20 is stored as a parameter in the subscriber identity module 31.

The configuration data can have a predetermined data structure so that it can preferably be stored in a SIM card or an e-SIM module. In a manner known per se, a SIM card or an e-SIM module contains a telephone book with name and call number fields, in which a call partner and his call number can normally be entered. Preferably, the configuration data is now entered in the telephone book of the SIM card 34, whereby preferably the parameter name “destination IP address” is entered in a name field and the parameter value, which represents the IP address of a predetermined remote station, is entered in a call number field of the telephone book.

Furthermore, the device 30 has a control unit 31, which is designed in particular to monitor and control the operation of the device 30. In the embodiment example shown, the device 30 can have a communication interface 36 that is implemented in accordance with a layer 2 protocol. In the present example, the layer 2 protocol is an Ethernet-based protocol, for example Profinet. For example, a communication system 70 that supports communication according to a layer 2 protocol, for example Profinet, can be connected to the communication interface 36. The communication system 70 comprises, for example, a field bus 72 and at least one actuator 71 connected to it, to which a MAC address is assigned.

The control unit 31 of the device 30 is preferably designed to retrieve the configuration data stored in the SIM card 34, for example the parameter name “target IP address” and the associated parameter value, which represents the IP address of the device 20, to interpret the parameter value or the corresponding sequence of digits as the IP address of the device 20 depending on the retrieved configuration data, and to execute the program stored in the memory device 35, causing the device 30 to encapsulate at least one layer 2 protocol data frame ready for transmission in an IP packet and to deliver the IP packet to the mobile radio communication interface 33 for transmission to the remote station, which may be the device 20. In this way, data intended for the device 20 can be inserted by the device 30 into layer 2 protocol data frames and then transmitted tunneled via IP packets to the device 20 via the mobile radio communication interface 33. Depending on the selected implementation, the control unit 31 can be designed to insert, for example, the parameter value interpreted as an IP address in the form of a proper IP address in the header of each IP packet to be transmitted to the device 20.

The automation system 10 shown as an example in FIG. 2 also has a mobile radio network 40, which is preferably completely installed on the factory premises 100 and implemented in accordance with a mobile radio standard. The exemplary mobile radio network 40 can be a private mobile radio network or a public mobile radio network, which can be used privately by the company of the automation system 10 within the automation system 10. In other words, the mobile radio network 40 may, for example, be a company-owned campus radio network or a virtual private mobile radio network.

The mobile radio network 40 has at least one base station 50, which can be designed as a transceiver station for wireless communication with the devices 20 and 30. The base station 50 is preferably installed on the factory premises 100. The base station 50 is preferably connected to a packet control unit 60, which may be part of an IP-based core network 80 of the mobile network 40. In the present example, the packet control unit 60 is designed as an external device which is connected to the core network 80. The IP-based core network 80 may comprise a plurality of routers (not shown) connected via lines in order to be able to route IP packets through the core network 80. Furthermore, the IP-based core network 80 can have an edge network element 110, for example in the form of a gateway or edge router 110. It should already be mentioned at this point that the edge network element 110 can be a remote station to which, depending on the selected tunnel configuration, the device 20, for example, can transmit IP data packets, each of which encapsulates a layer 2 protocol data frame. For this purpose, an IP address can be assigned to the edge network element 110, which can be stored, for example, in a memory device 111. Furthermore, the edge network element 110 can have a first communication interface 112, which is implemented in accordance with the IP protocol. The communication interface 112 is designed to receive IP data packets received via the base station 50 and forwarded via the IP-based core network 80. Furthermore, the edge network element 110 can have a second communication interface 113, which is implemented according to a layer 2 protocol. The layer 2 protocol may be an Ethernet-based protocol, for example the Profinet protocol. The memory device 111 can also store a program that implements the IP-based tunnel protocol, which is also implemented by the program stored in the memory device 25 or 35. The operation of the edge network element 110 is monitored and controlled by a control unit 114.

The functionality of the mobile network-based automation system 10 shown in FIG. 2 will now be explained in more detail.

In a first scenario, it is assumed that process data, for example temperature data, is to be transmitted from the device 20 acting as a sensor to the device 30. Based on the tunnel configuration data stored in the subscriber identity module 24, which contains, for example, the parameter name “destination IP address” and a parameter value representing the IP address of the device 30, the device 20 knows that process data is to be transmitted to the device 30 via the mobile network 40.

If process data, e.g. temperature measurement data, is now available in the device 20, it is inserted by the device 20 into a single layer 2 protocol data frame, for example, whereby the Profinet protocol is used as the layer 2 protocol in this example. In addition, it is assumed as an example that the MAC address of the device 20 is also inserted into the layer 2 protocol data frame in addition to the process data.

The control unit 21 can be designed to first read out the parameter name and the associated parameter value from the SIM card 24, to interpret the parameter value as a function of the parameter name, for example as the IP address of the device 30, and to execute the program stored in the memory device 25 as a function of this, causing the device 20 to encapsulate the layer 2 protocol data frame containing the process data in an IP packet, which also contains the parameter read out from the subscriber identity module in the form of the IP address of the device 30. The IP packet is transferred to the mobile communication interface 23 and then transmitted by means of the antenna 21 in accordance with the implemented mobile radio standard via a radio link to the base station 50 of the private mobile radio network 40. According to an exemplary implementation, the received IP packet 50 is fed to the packet control device 60, which recognizes from the IP address contained in the IP packet that the desired remote station, i.e. the device 30, can be reached via the base station 50. The packet control device 60 now initiates the transmission of the IP packet received from the device 20 via the base station 50 to the device 30.

The device 30 is designed to receive the IP packet via the antenna 32 and the mobile radio communication interface 33. By executing the program stored in the memory device 35, which also implements the IP-based tunnel protocol, the control device 31 causes the device 30 to decapsulate the layer 2 protocol data frame contained in the IP packet and, for example, to read out the process data contained in the layer 2 protocol data frame and, depending on the implementation, to process it.

For example, the device 30 can calculate corresponding control data for the actuator 71 from the received process data. In this case, the device 30 can be configured and designed such that the control data, which has been generated in dependence of the received process data, is transmitted to the actuator 71 in a layer 2 protocol data frame, in the present case a Profinet data frame, via the communication interface 36 and the field bus 72. For this purpose, a mapping between the MAC address of the device 20 and the MAC address of the actuator 71 is stored in the device 30, which can be accessed by the control unit 31. Since the control unit 30 can also be designed to read out the MAC address of the device 20 contained in a layer 2 protocol data frame that has been received in an IP packet from the device 20, it can determine that there is a process-relevant link between the device 20 and the actuator 30.

A second exemplary scenario is now considered. Assume that process data, for example temperature data, is to be transmitted from the device 20 acting as a sensor to the edge network element 110. Based on the tunnel configuration data stored in the subscriber identity module 24, which contains, for example, the parameter name “destination IP address” and the associated parameter value, which now represents the IP address of the edge network element 110 as the IP address of the remote station, the device 20 knows that process data is to be transmitted to the edge network element 110 via the mobile radio network 40.

If process data, e.g. temperature measurement data, is now available in the device 20, it is inserted by the device 20 into a single layer 2 protocol data frame, for example, whereby Profinet is used as the layer 2 protocol in the present example. In addition, it is assumed as an example that the MAC address of the device 20 and the MAC address of the actuator 102 are inserted into the layer 2 protocol data frame in addition to the process data.

The control unit 21 can be designed to first read out the parameter name and the associated parameter value from the SIM card 24, to interpret the parameter value as a function of the parameter name as the IP address of the device 110, and to execute the program stored in the memory device 25 as a function of this, causing the device 20 to encapsulate the layer 2 protocol data frame containing the process data in an IP packet, which also contains the parameter read out from the subscriber identity module in the form of the IP address of the edge element 110. The IP packet is transferred to the mobile communication interface 23 and then transmitted by means of the antenna 21 in accordance with the implemented mobile radio standard via a radio link to the base station 50 of the private mobile radio network 40.

According to an exemplary implementation, the received IP packet 50 is fed to the packet control device 60, which recognizes from the IP address contained in the IP packet that the desired remote station, i.e. the edge network element 110, can be reached via the IP-based core network 80. The packet control device 60 now causes the IP packet received from the device 20 to be transmitted via the IP-based core network 80 to the communication interface 112 of the edge network element 110. By executing the program stored in the memory device 111, which implements the IP-based tunnel protocol, the control unit 114 causes the edge network element 110 to decapsulate the layer 2 protocol data frame contained in the received IP packet. The control unit 114 can be designed to output the decapsulated layer 2 protocol data frame to the fieldbus 101 via the communication interface 113. The actuator 102 connected to the fieldbus 101 is designed, for example, to read out the MAC addresses contained in the layer 2 protocol data frame and to recognize that the layer 2 protocol data frame is intended for it. The actuator 102 can also be designed to read out the process data contained in the layer 2 protocol data frame and process it accordingly. For example, the actuator 102 can be an intelligent actuator that can be designed to calculate control data for a connected machine from the process data.

It should be noted that the exemplary mobile radio network-based automation system 10 or its components could also be implemented in a widely distributed manner in an open area.

For example, the device 30 could act as a central control unit to monitor water levels in a river. In this case, the mobile radio network 40 would preferably be a public mobile radio network. Water level measuring stations could be set up widely distributed along the river to measure the water levels. One such level measuring point could be, for example, the device 20, which is modified accordingly. The device 20 could then transmit a measured water level to the device 30 via the mobile phone network 40 in the manner described above. It is conceivable that the device 30 acting as a controller could generate control data depending on the water level measured by the device 20 and the measured values received from the other water level measuring points, for example to control a flood gate. Such a flood gate could, for example, be realized by the actuator 102. In this case, the device 30 would transmit corresponding control data to the actuator 102 via the mobile network 40 and the edge network element 110. However, it is also conceivable that the device 20, which has been converted into a level measuring point, could itself transmit its level measurement values to the actuator 102 in a manner corresponding to that described above.

At least some of the aspects explained above as examples are summarized again below:

According to an advantageous aspect, a device 20, 30 for use in a mobile radio network-based automation system 10 is created, wherein the device 20, 30 may comprise the following features:
a mobile radio communication interface 23, 33, which is preferably designed for wireless data transmission in accordance with a mobile radio standard,
a memory device 25, 35, in which a program is stored which implements an IP-based tunnel protocol,
a subscriber identity module 24, 34, in which configuration data is stored, the configuration data containing at least one parameter name and a parameter value which is assigned to the at least one parameter name and represents the IP address of a remote station 30 and/or 110, and
a control unit 21 which is designed to retrieve the configuration data stored in the subscriber identification module 24, to execute the stored program in dependence of the retrieved configuration data and by executing the stored program, to cause the device to encapsulate at least one layer 2 protocol data frame ready for transmission in an IP packet and to transfer the IP packet to the mobile radio communication interface for transmission to the remote station.

It should be mentioned that the configuration data can contain several parameters, each of which can represent the IP addresses of further remote stations, and associated parameter names. This also means that the control unit 21, 31 can be designed to encapsulate at least one layer 2 protocol data frame ready for transmission in an IP packet and to transfer the IP packet to the mobile radio communication interface for transmission to at least one remote station.

Advantageously, the configuration data can contain further parameter values, such as a parameter value for the length of the IP packets to be transmitted, and various parameter names which, for example, refer to the IP address of a remote station and/or the length of an IP packet.

Advantageously, the control unit 21 can be designed to interpret the associated parameter value as the IP address of the remote station 30 and/or 110 in response to the at least one parameter name and to convert it into a formally correct IP address, and to insert the converted IP address into a header field of the IP packet to be transmitted.

Advantageously, the subscriber identity module 24, 34 may be a SIM card or an e-SIM module in which the configuration data is stored in a predetermined data structure.

Advantageously, the subscriber identity module 24, 34 includes a telephone book, wherein the at least one parameter name may be entered in a name field and the parameter value associated with the at least one parameter name may be entered in a call number field of the telephone book.

Preferably, the device 20, 30 may be adapted to receive an IP packet comprising a layer 2 protocol data frame, which has been formed according to the IP-based tunneling protocol, at the mobile radio communication interface 23 or 33, to decapsulate it and to provide the layer 2 protocol data frame for further processing.

The device 20, 30 may comprise a communication interface 26 or 36, respectively, configured to transmit and receive layer 2 protocol data frames.

The communication interface 26 or 36 can be designed to connect to a communication system implemented according to a layer 2 protocol, for example a field bus system.

Preferably, the layer 2 protocol data frames are Ethernet protocol data frames, wherein the communication interface 26, 36 may be formed according to an Ethernet protocol.

The device 20 or 30 can, for example, be designed as a router, a field device—e.g. a sensor or actuator —, a control device or an I/O module.

The IP-based tunnel protocol can be, for example, the Generic Routing Encapsulation (GRE) network protocol, a VPN (Virtual Private Network) protocol, an IPsec protocol, an L2TP (Layer 2 Tunneling Protocol).

According to a further exemplary aspect, a mobile network-based automation system 10 is provided, which may have the following features:
at least one remote station 30 and/or 110, to which an IP address is assigned,
at least one first device 20, which is configured in accordance with one of the preceding aspects, wherein configuration data is stored in the subscriber identity module 24 of the first device 20, wherein the configuration data contains at least one parameter name and a parameter value assigned to the at least one parameter name, which parameter value represents the IP address of a remote station 30 and/or 110,
a mobile radio network 40, wherein
the control unit 21 of the first device 20 is designed to retrieve the configuration data stored in the subscriber identity module 24, to execute the stored program in dependence of the configuration data and by executing the stored program, to cause the first device 20 to
encapsulate at least one layer 2 protocol data frame ready for transmission in an IP packet and to transmit the IP packet to the remote station 30 and/or 110 via the mobile radio communication interface 23 and the mobile radio network 40.

The remote station may be a second device 30, which may be formed according to one of the above exemplary aspects, wherein the second device 30 is adapted to receive the IP packet transmitted by the first device 20, which has been formed according to the IP-based tunneling protocol, at the mobile radio communication interface 33 of the second device 30, to decapsulate it and to provide the layer 2 protocol data frame contained in the IP packet for further processing.

Preferably, the mobile radio network 40 may comprise an IP-based core network 80, wherein the remote station may be an edge network element 110, in particular an edge router of the IP-based core network 80, and may comprise the following features:
a first communication interface 113 implemented according to a layer 2 protocol,
a second communication interface 112 implemented according to the IP protocol, wherein the first communication interface 113 is designed to connect to a communication system 100, in particular a field bus system, implemented according to the layer 2 protocol,
a memory device 111 in which a program which implements the IP-based tunnel protocol is stored, which implements the IP-based tunneling protocol, wherein the remote station 110 can be designed to receive the IP packet transmitted by the first device 20, which has been formed in accordance with the IP-based tunneling protocol, at the second communication interface 112, to decapsulate it and to provide the layer 2 protocol data frame contained in the IP packet for forwarding via the first communication interface 113.

Preferably, the mobile radio network 40 is a private mobile radio network. However, the mobile radio network 40 can also be a public mobile radio network.

Preferably, the mobile radio-based automation system 10 is installed on a company site. However, the mobile radio-based automation system 10 can also be installed in a widely distributed location in an open area.

1. A device for use in a mobile radio network-based automation system, the device having the following features;
a mobile radio communication interface,
a memory device in which a program is stored which implements an IP-based tunneling protocol,
a subscriber identity module in which configuration data is stored, the configuration data containing at least one parameter name and a parameter value which is assigned to the at least one parameter name and represents the IP address of a remote station, and
a control unit which is designed to retrieve the configuration data stored in the subscriber identification module, to execute the stored program in dependence of the retrieved configuration data and by executing the stored program to cause the device to encapsulate at least one layer 2 protocol data frame ready for transmission in an IP packet and to transfer the IP packet to the mobile radio communication interface for transmission to the remote station.

2. The device according to claim 1, wherein:
the subscriber identity module is a SIM card or an e-SIM module in which the configuration data is stored in a predetermined data structure.

3. The device according to claim 2, wherein:
the subscriber identity module contains a telephone book, wherein the at least one parameter name is entered in a name field and the parameter value is entered in a call number field of the telephone book.

4. The device according to claim 1, wherein:
the device is designed to receive an IP packet containing a layer 2 protocol data frame, which has been formed according to the IP-based tunneling protocol, at the mobile radio communication interface, to decapsulate it and to provide the layer 2 protocol data frame for further processing.

5. The device according to claim 1, further comprising:
a communication interface configured to transmit and receive layer 2 protocol data frames.

6. The device according to claim 5, wherein:
the communication interface is designed for connection to a communication system implemented according to a layer 2 protocol, the communication system comprising a field bus system.

7. The device according to claim 5, wherein:
the layer 2 protocol data frames are Ethernet protocol data frames and that the communication interface is designed in accordance with an Ethernet protocol.

8. The device according to claim 1, wherein:
the device is designed as a router, a field device, a control device or as an I/O module.

9. The device according to claim 4, wherein:
the IP-based tunneling protocol is the Generic Routing Encapsulation network protocol, a VPN (Virtual Private Network) protocol, an IPsec protocol, an L2TP (Layer 2 Tunneling Protocol).

10. The device according to claim 1, wherein:
the control unit is designed to interpret the associated parameter value as the IP address of the remote station in response to the at least one parameter name and to insert this IP address into a header field of the transmitted IP packet.

11. A mobile radio network-based automation system, comprising:
at least one remote station to which an IP address is assigned,
at least one first device comprising:
a mobile radio communication interface,
a memory device in which a program is stored which implements an IP-based tunneling protocol,
a subscriber identity module in which configuration data is stored, and
a control unit,
wherein configuration data is stored in the subscriber identity module of the at least one first device, wherein the configuration data contains at least one parameter name and a parameter value which is assigned to the at least one parameter name and represents the IP address of a remote station,
a mobile radio network, wherein:
the control unit of the at least one first device is designed to retrieve the configuration data stored in the subscriber identity module, to execute the stored program in dependence of the retrieved configuration data and by executing the stored program, to cause the first device to encapsulate at least one layer 2 protocol data frame ready for transmission in an IP packet and to transmit the IP packet to the at least one remote station via the mobile radio communication interface and the mobile radio network.

12. The mobile radio network-based automation system according to claim 11, wherein:
the remote station is a second device that is designed to receive the IP packet transmitted by the at least one first device, which has been formed according to the IP-based tunneling protocol, at a mobile radio communication interface of the second device, to decapsulate it and to provide the layer 2 protocol data frame contained in the IP packet for further processing.

13. The mobile radio network-based automation system according to claim 11, wherein:
the mobile radio network has an IP-based core network, the remote station being an edge network element, comprising an edge router of the IP-based core network, and having:
a first communication interface implemented in accordance with a layer 2 protocol,
a second communication interface implemented in accordance with the IP protocol, the first communication interface being designed for connecting to a communication system comprising a field bus system, implemented in accordance with the layer 2 protocol,
a memory device in which a program implementing the IP-based tunneling protocol is stored, wherein:
the remote station is designed to receive the IP packet transmitted by the at least one first device, which has been formed in accordance with the IP-based tunneling protocol, at the second communication interface, to decapsulate it and to provide the layer 2 protocol data frame contained in the IP packet available for forwarding via the first communication interface.

14. The mobile radio network-based automation system according to claim 11, wherein:
the mobile radio network is a private mobile radio network.
